(19) United States
(12) Patent Application Publication
(10) Pub. No.: US 2025/0332875 A1
(43) Pub. Date: Oct. 30, 2025

(54) Powerline Communication Wi-Fi Camera Authentication And Video Transmission

(71) Applicant: Panasonic Automotive Systems Company of America, Division of Panasonic Corporation of North America, PEACHTREE CITY, GA (US)

(72) Inventor: JOSEPH THOMAS PERRY, OXFORD, MI (US)

(21) Appl. No.: 19/096,142

(22) Filed: Mar. 31, 2025

Related U.S. Application Data
(60) Provisional application No. 63/640,419, filed on Apr. 30, 2024.

(51) Int. Cl. B60D 1/62; B60R 1/26; B60R 11/04; B60R 16/03

(52) U.S. Cl. CPC B60D 1/62; B60R 1/26; B60R 16/03; B60R 11/04

(57) ABSTRACT

A power and communication transmission arrangement includes an electronic accessory having a first modulator/demodulator. A motor vehicle includes a charging system to provide a power signal to the electronic accessory. At least one electrical conductor carries the power signal from the charging system to the electronic accessory. An infotainment system bi-directionally communicates with the electronic accessory. A second modulator/demodulator modulates the power signal based upon first signals received from the infotainment system to form first modulated power signals such that the first modulator/demodulator demodulates the first modulated power signals to extract the first signals for use in the electronic accessory. The first modulator/demodulator modulates the power signal based upon second signals from the electronic accessory to form second modulated power signals such that the second modulator/demodulator demodulates the second modulated power signals to extract the second signals for use in the infotainment system.

### CROSS-REFERENCE TO RELATED APPLICATIONS

This application claims benefit of U.S. Provisional Application No. 63/640,419, filed on Apr. 30, 2024, the disclosure of which is hereby incorporated by reference in its entirety for all purposes.

### FIELD OF THE INVENTION

The disclosure relates to a motor vehicle authorizing and communicating with a Wi-Fi camera.

### BACKGROUND OF THE INVENTION

Supplemental accessories such as hardwire-powered Wi-Fi cameras require authentication by the host motor vehicle for security reasons. This typically requires the camera hardware to be disposed near the vehicle cabin in order to connect to the host and be authenticated. This connection and authentication can be difficult if the camera has already been mounted at an out-of-reach or relatively remote location. Currently, external hardware requires manual authenticating through conventional pairing methods (e.g., personal identification numbers (PINs), passwords, QR codes), as well as a way to pass the video file via Wi-Fi or other direct video methods.

### SUMMARY

The present invention may utilize bi-directional powerline communication by modulating a motor vehicle's power output to control/authenticate hardware accessories such as direct current (DC) hardwired trailer Wi-Fi cameras that are externally connected to the host vehicle. The invention may also utilize bi-directional powerline communication to control actions in the host vehicle through the power wiring. This may be accomplished using a modulator/demodulator in the vehicle and a modulator/demodulator in the accessory. The invention may provide a secondary method of obtaining a video feed in a vehicle that does not have the Wi-Fi hardware. The invention may negate the need for the authentication, and potentially the extra video-sending hardware.

By virtue of authenticating the accessory through powerline communication, the connection to the accessory may be automatic. Powerline communication may also enable the accessory to interact with the host vehicle in order to remotely control features such as a radio or exterior lighting. Transmitting the video data feed through the powerlines via modulation may also eliminate the need for Wi-Fi hardware.

In one embodiment, the invention comprises a power and communication transmission arrangement including an electronic accessory having a first modulator/demodulator. A motor vehicle includes a charging system to provide a power signal to the electronic accessory. At least one electrical conductor carries the power signal from the charging system to the electronic accessory. An infotainment system bi-directionally communicates with the electronic accessory. A second modulator/demodulator modulates the power signal based upon first signals received from the infotainment system to form first modulated power signals such that the first modulator/demodulator demodulates the first modulated power signals to extract the first signals for use in the electronic accessory. The first modulator/demodulator modulates the power signal based upon second signals from the electronic accessory to form second modulated power signals such that the second modulator/demodulator demodulates the second modulated power signals to extract the second signals for use in the infotainment system.

In another embodiment, the invention comprises a power and communication transmission method for a motor vehicle, including carrying a power signal from the motor vehicle to an electronic accessory. The power signal is modulated based upon first signals received from an infotainment system of the motor vehicle to form first modulated power signals. The first modulated power signals are demodulated to extract the first signals. The first signals are used in the electronic accessory. The power signal is modulated based upon second signals from the electronic accessory to form second modulated power signals. The second modulated power signals are demodulated to extract the second signals. The second signals are used in the infotainment system.

In yet another embodiment, the invention comprises a power and communication transmission arrangement including a camera, a first modulator/demodulator, and a motor vehicle. The motor vehicle includes a charging system that provides a power signal. At least one electrical conductor carries the power signal and provides electrical power to the camera from the charging system. An infotainment system bi-directionally communicates with the camera. A second modulator/demodulator modulates the power signal based upon first signals received from the infotainment system to form first modulated power signals such that the first modulator/demodulator demodulates the first modulated power signals to extract the first signals for use in the camera. The first modulator/demodulator modulates the power signal based upon video signals from the camera to form second modulated power signals such that the second modulator/demodulator demodulates the second modulated power signals to extract the video signals for use in the infotainment system.

### BRIEF DESCRIPTION OF THE DRAWINGS

A better understanding of the present invention will be had upon reference to the following description in conjunction with the accompanying drawings.

FIG. 1 is a schematic side view of one embodiment of a powerline communication and video transmission arrangement of the present invention.

FIG. 2 is a flow chart of one embodiment of a power and communication transmission method of the present invention for a motor vehicle.

### DETAILED DESCRIPTION OF THE PREFERRED EMBODIMENTS

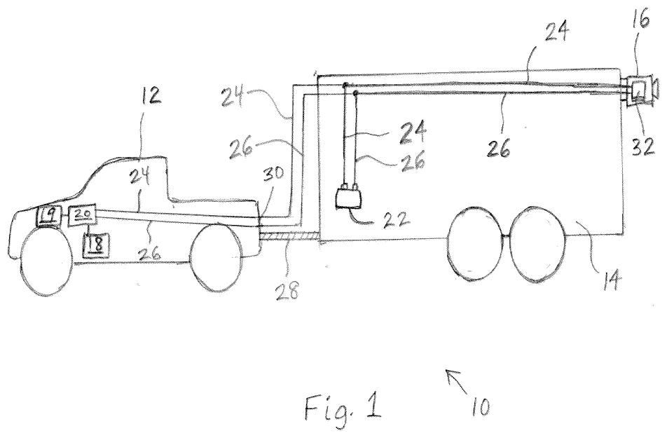

FIG. 1 illustrates one embodiment of a powerline communication and video transmission arrangement 10 of the present invention, including a truck 12 and a trailer 14 having a Wi-Fi camera 16 mounted thereon. Truck 12 includes an infotainment system 18 and a vehicle charging system 19 having a modulator/demodulator 20 connected thereto or integrated therein. Infotainment system 18 may include an electronic processor controlling a display screen, loudspeakers, and other forms of user interface.

The combination of charging system 19 and modulator/demodulator 20 may be connected to a battery 22 of trailer 14 via a positively charged power line 24 and a ground line 26. Truck 12 may be mechanically coupled to trailer 14 via a hitch 28 including a power/light connector 30 by which the portion of power line 24 that is disposed in truck 12 may be quickly connected/disconnected from the portion of power line 24 that is disposed in trailer 14. Similarly, power/light connector 30 may enable the portion of ground line 26 that is disposed in truck 12 to be quickly connected/disconnected from the portion of ground line 26 that is disposed in trailer 14.

Power line 24 and ground line 26 may be further connected to camera 16 to thereby provide electrical power to camera 16. Camera 16 may include a modulator/demodulator 32 that is also connected to power line 24 and ground line 26. Camera 16 may also include an electronic processor that controls the operation of camera 16 and that is in communication with modulator/demodulator 32.

During use, charging system 19 may directly provide power to camera 16 through modulator/demodulator 20 and the combination of power line 24 and ground line 26. Charging system 19 may also indirectly provide power to camera 16 by charging battery 22 through modulator/demodulator 20 and the combination of power line 24 and ground line 26. Battery 22 may then directly provide power to camera 16.

Infotainment system 18 may authenticate, pair with, control, receive video signals from, and otherwise communicate with camera 16 through modulator/demodulator 20, power line 24, ground line 26 and modulator/demodulator 32. Charging system 19 may provide a constant direct current voltage to modulator/demodulator 20, such as 12 Volts DC. When infotainment system 18 has a signal or other information to send to camera 16, such as for camera authentication, infotainment system 18 may send the signal to modulator/demodulator 20 via a hard-wired connection. Modulator/demodulator 20 may modulate the +12 VDC on lines 24, 26 such that the signal from infotainment system 18 as well as the +12 VDC is carried on lines 24, 26.

Modulator/demodulator 32 in camera 16 may receive the modulated power signal on lines 24, 26 and demodulate the modulated signal to thereby extract the signal that was sent by infotainment system 18. The demodulated signal may then be sent to the processor that controls camera 16 for processing thereby. The +12 VDC signal carried on lines 24, 26, in either its modulated or demodulated state, may be used to power camera 16.

The processor that controls camera 16 may transmit signals, such as video signals, to infotainment system 18 in much the same way that infotainment system 18 sends signals to the camera processor as described above. The camera processor may transmit video signals and otherwise communicate with infotainment system 18 through modulator/demodulator 32, power line 24, ground line 26 and modulator/demodulator 20. When the camera processor has a video signal or other information to send to infotainment system 18, the camera processor may send the video signal to modulator/demodulator 32 via a hard-wired connection. Modulator/demodulator 32 may modulate the +12 VDC on lines 24, 26 such that the signal from the camera processor as well as the +12 VDC is carried on lines 24, 26.

Modulator/demodulator 20 in vehicle 12 may receive the modulated power signal on lines 24, 26 and demodulate the modulated signal to thereby extract the video signal that was sent by the camera processor. The demodulated video signal may then be sent to infotainment system 18 for processing thereby. The processed and demodulated video signal may then be presented on a display screen of infotainment system 18.

The modulation of the constant DC power signal may be performed with any conventional modulation technique, including either digital modulation or analog modulation.

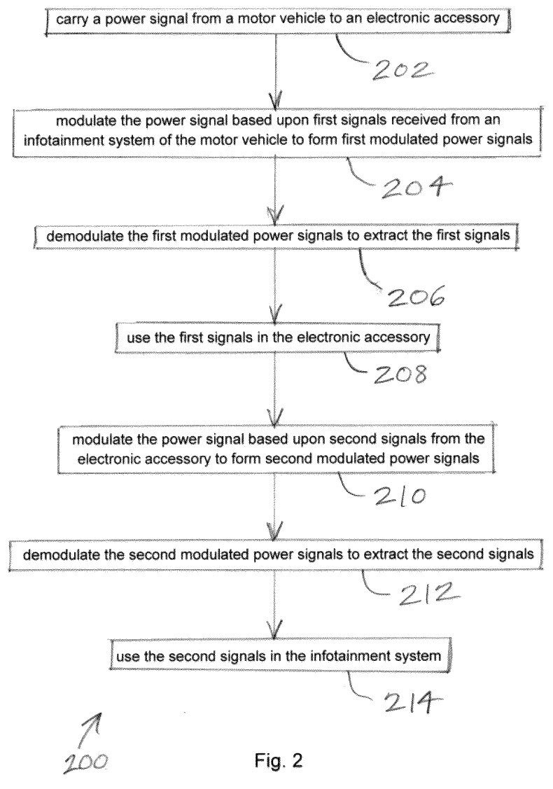

FIG. 2 illustrates one embodiment of a power and communication transmission method 200 of the present invention for a motor vehicle. In a first step 202, a power signal is carried from the motor vehicle to an electronic accessory. For example, charging system 19 may directly provide power to camera 16 through modulator/demodulator 20 and the combination of power line 24 and ground line 26.

Next, in step 204, the power signal is modulated based upon first signals received from an infotainment system of the motor vehicle to form first modulated power signals. For example, when infotainment system 18 has a signal or other information to send to camera 16, such as for camera authentication, infotainment system 18 may send the signal to modulator/demodulator 20 via a hard-wired connection. Modulator/demodulator 20 may modulate the +12 VDC power signal on lines 24, 26 such that the signal from infotainment system 18 as well as the +12 VDC power signal is carried on lines 24, 26.

In a next step 206, the first modulated power signals are demodulated to extract the first signals. For example, modulator/demodulator 32 in camera 16 may receive the modulated power signal on lines 24, 26 and demodulate the modulated signal to thereby extract the signal that was sent by infotainment system 18.

In step 208, the first signals are used in the electronic accessory. For example, the demodulated signal may be sent to the processor that controls camera 16 for processing thereby and for use by camera 16.

Next, in step 210, the power signal is modulated based upon second signals from the electronic accessory to form second modulated power signals. For example, when the camera processor has a video signal or other information to send to infotainment system 18, the camera processor may send the video signal to modulator/demodulator 32 via a hard-wired connection. Modulator/demodulator 32 may modulate the +12 VDC on lines 24, 26 such that the signal from the camera processor as well as the +12 VDC is carried on lines 24, 26.

In a next step 212, the second modulated power signals are demodulated to extract the second signals. For example, modulator/demodulator 20 in vehicle 12 may receive the modulated power signal on lines 24, 26 and demodulate the modulated signal to thereby extract the video signal that was sent by the camera processor.

In a final step 214, the second signals are used in the infotainment system. For example, the demodulated video signal may then be sent to infotainment system 18 for processing thereby. The processed and demodulated video signal may then be presented on a display screen of infotainment system 18.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed:

1. A power and communication transmission arrangement comprising:
an electronic accessory including a first modulator/demodulator; and
a motor vehicle including:
a charging system configured to provide a power signal to the electronic accessory;
at least one electrical conductor configured to carry the power signal from the charging system to the electronic accessory;
an infotainment system configured to bi-directionally communicate with the electronic accessory; and
a second modulator/demodulator configured to modulate the power signal based upon first signals received from the infotainment system to form first modulated power signals such that the first modulator/demodulator demodulates the first modulated power signals to extract the first signals for use in the electronic accessory, and wherein the first modulator/demodulator is configured to modulate the power signal based upon second signals from the electronic accessory to form second modulated power signals such that the second modulator/demodulator demodulates the second modulated power signals to extract the second signals for use in the infotainment system.

2. The power and communication transmission arrangement of claim 1 wherein the electronic accessory comprises a Wi-Fi camera.

3. The power and communication transmission arrangement of claim 2 wherein the infotainment system includes a display screen, the second signals include video signals, the infotainment system being configured to present the video signals on the display screen.

4. The power and communication transmission arrangement of claim 3 further comprising a trailer hitched to the motor vehicle, wherein the Wi-Fi camera is mounted on a rear end of the trailer.

5. The power and communication transmission arrangement of claim 1 wherein the power signal comprises a constant direct current power signal.

6. The power and communication transmission arrangement of claim 1 wherein the at least one electrical conductor comprises a power wire and a ground wire.

7. The power and communication transmission arrangement of claim 1 wherein the first signals include authentication signals.

8. A power and communication transmission method for a motor vehicle, the method comprising:
carrying a power signal from the motor vehicle to an electronic accessory;
modulating the power signal based upon first signals received from an infotainment system of the motor vehicle to form first modulated power signals;
demodulating the first modulated power signals to extract the first signals;
using the first signals in the electronic accessory;
modulating the power signal based upon second signals from the electronic accessory to form second modulated power signals;
demodulating the second modulated power signals to extract the second signals; and
using the second signals in the infotainment system.

9. The power and communication transmission method of claim 8 wherein the electronic accessory comprises a Wi-Fi camera.

10. The power and communication transmission method of claim 9 wherein the infotainment system includes a display screen, the second signals include video signals, the step of using the second signals in the infotainment system including presenting the video signals on the display screen.

11. The power and communication transmission method of claim 10 further comprising:
hitching a trailer to the motor vehicle; and
mounting the Wi-Fi camera on a rear end of the trailer.

12. The power and communication transmission method of claim 8 wherein the power signal comprises a constant direct current power signal.

13. The power and communication transmission method of claim 8 wherein the power signal is carried by a power wire and a ground wire.

14. The power and communication transmission method of claim 8 wherein the first signals include authentication signals.

15. A power and communication transmission arrangement comprising:
a camera;
a first modulator/demodulator; and
a motor vehicle including:
a charging system configured to provide a power signal;
at least one electrical conductor configured to carry the power signal and provide electrical power to the camera from the charging system;
an infotainment system configured to bi-directionally communicate with the camera; and
a second modulator/demodulator configured to modulate the power signal based upon first signals received from the infotainment system to form first modulated power signals such that the first modulator/demodulator demodulates the first modulated power signals to extract the first signals for use in the camera, and wherein the first modulator/demodulator is configured to modulate the power signal based upon video signals from the camera to form second modulated power signals such that the second modulator/demodulator demodulates the second modulated power signals to extract the video signals for use in the infotainment system.

16. The power and communication transmission arrangement of claim 15 wherein the camera comprises a Wi-Fi camera.

17. The power and communication transmission arrangement of claim 16 wherein the infotainment system includes a display screen, the infotainment system being configured to present the video signals on the display screen.

18. The power and communication transmission arrangement of claim 17 further comprising a trailer hitched to the motor vehicle, wherein the Wi-Fi camera is mounted on a rear end of the trailer.

19. The power and communication transmission arrangement of claim 15 wherein the power signal comprises a constant direct current power signal.

20. The power and communication transmission arrangement of claim 15 wherein the at least one electrical conductor comprises a power wire and a ground wire.
